(19) United States
(12) Patent Application Publication
(10) Pub. No.: US 2006/0032574 A1
(43) Pub. Date: Feb. 16, 2006

(54) Method for fabricating multi-layer ceramic substrate

(76) Inventors: Jen-I Kuo, Chiayii (TW); Jih-Hwa Lee, Lungtan Shiang (TW); Haun-Yu Wang, Jhubei City (TW)

Correspondence Address: J C PATENTS, INC., 4 VENTURE, SUITE 250, IRVINE, CA, 92618, US

(21) Appl. No.: 10/917,007

(22) Filed: Aug. 11, 2004

(51) Int. Cl. C03B 29/00; B32B 37/00; B32B 38/10

(52) U.S. Cl. 156/89.11; 156/89.12; 156/247; 156/289

(57) ABSTRACT

A method for fabricating a multi-layer ceramic substrate is disclosed. The method compresses multi-layer green tapes by a mold apparatus having an upper mold and a lower mold. The method provides a carrying board and multi-layer green tapes over the lower mold. The method compresses the green tapes by the upper mold and the lower mold. The green tapes are parted from the upper mold. The carrying board is parted from the lower mold. The carrying board is parted from the green tapes.

### BACKGROUND OF THE INVENTION

1. Field of the Invention

The present invention relates to a method for fabricating a multi-layer ceramic substrate, and more particularly to a method for fabricating a high-planar multi-layer ceramic substrate.

2. Description of the Related Art

With advance of electronic technology, electronic devices have been widely used in the world. Chips are the core of electronic devices. By logic operations of chips, electronic devices perform different functions. In order to integrate different chips, a substrate for carrying these chips is required. Usually, substrates are made of ceramic, glass or plastic. Because ceramic substrates have excellent thermal expansion coefficient match with that of silicon devices, big-size chips can be attached to the ceramic substrate without detaching from the ceramic substrate. Moreover, ceramic substrates do not absorb moistures in the air. Accordingly, the popcorn effect and peeling effect can be avoided while packaging. Compared with plastic substrates, ceramic substrates provide more I/O pins in each unit area.

A ceramic substrate is formed by sintering ceramic green tapes and metal ink in which the ceramic green tapes comprise glass powders, ceramic powders, dispersants and adhesives. In the prior art method for fabricating the ceramic substrate, a plurality of holes are formed within the green tapes by laser or mechanical drilling. The metal ink is filled into the holes of the green tapes and circuits are printed on the green tapes. A multiple layers of the filled-and-printed green tapes are layered. Under a specified temperature, the green tapes are compressed. The green tapes are then parted from the mold apparatus. During the parting process, the ceramic green tapes are subject to distortion due to the pegs. A second compression step is required after removing the pegs and the remaining material. During the sintering process, organic material is driven away from the green tapes by thermal heating. A higher temperature is used for solidifying the green tapes. Planeness is essential for the multi-layer ceramic substrate. If the ceramic substrate has undesired planeness or high camber, this would cause circuit failed or the heat dissipation issue.

Following are the descriptions of a prior art method for resolving the camber issue while parting the multi-layer green tapes from the mold apparatus. FIG. 1 is a cross sectional view showing a prior art pre-parting multi-layer green tapes. The mold apparatus 150 comprises an upper mold 152 and a lower mold 154. The lower mold 154 comprises a plurality of pegs 156 for fixing the green tapes 110a-110d over the lower mold 154. After forming a circuit pattern (not shown) on the green tapes 110a-110d, a layering process is performed. The plastic mold 120a is provided over the lower mold 154. The green tapes 110a-110d are sequentially provided over the plastic mold 120a. The plastic mold 120b is then disposed over the green tape 110d. The plastic molds 120a and 120b, and the green tapes 110a-110d comprise holes 122 and 112. During the layering process, the pegs 156 of the lower mold 154 fit into the holes 122 and 112 of the plastic molds 120a and 120b, and the green tapes 110a-110d. Accordingly, the plastic molds 120a and 120b, and the green tapes 110a-110d can be fixed over the lower mold 154.

After providing the plastic mold 120b over the green tapes 110d, the upper mode 152 covers the plastic mold 120b. Then a compression process is performed. In the prior art method, a two-step compression method is required in order to maintain the planeness of the post-sintering green tapes 110a-110d. A low-pressure compression step is performed so as to slightly stick the green tapes 110a-110d. The green tapes 110a-110d are parted from the first mold 152 and the lower mold 154. Because the green tapes 110a-110d are adhesive to the pegs 156, the parting process will distort the green tapes 110a-110d. Accordingly, an additional compression process is required. Under a specified temperature of the high-pressure compression, the green tapes can tightly adhere to each other and a planar and solid green-tape stack structure is formed. After the sintering process, a planar ceramic substrate is thus formed.

However, the prior art method requires a two-step compression method to maintain the planeness of the green tapes 110a-110d. The method is not cost-effective.

### SUMMARY OF THE INVENTION

Accordingly, the present invention is directed to a method for fabricating a multi-layer ceramic substrate. By only one compressing step, the present invention fabricates a substantially planar multi-layer ceramic substrate.

In order to achieve the object described above, the present invention discloses a method for fabricating a multi-layer ceramic substrate by using a mold apparatus comprising an upper mold and a lower mold to compress a plurality of green tapes. The method comprises first providing a carrying board over the lower mold. The method provides the green tapes over the carrying board. The method then compresses the green tapes with the upper mold and the lower mold. The method parts the upper mold from the green tapes and parts the lower mold from the carrying board. The method parts the green tapes from the carrying board.

In order to make the aforementioned and other objects, features and advantages of the present invention understandable, a preferred embodiment accompanied with figures is described in detail below.

### BRIEF DESCRIPTION OF THE DRAWINGS

FIG. 1 is a cross sectional view showing a prior art pre-parting multi-layer green tapes.

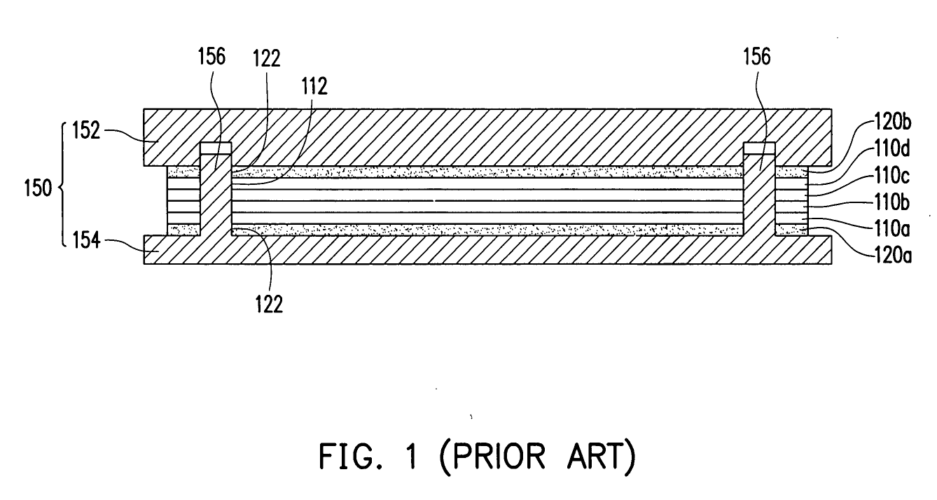

FIG. 2 is a cross sectional view showing a pre-parting multi-layer green tapes according to an embodiment of the present invention.

FIG. 3 is a cross sectional view showing another pre-parting multi-layer green tapes according to an embodiment of the present invention.

### DESCRIPTION OF SOME EMBODIMENTS

Following are the descriptions of a first embodiment. Compared with prior art technology, the present invention uses a carrying board. The present invention provides the carrying board between the green tapes and the lower mold. While the parting process, the green tapes can be separated from the lower mold by lifting the carrying board so as to maintain the planeness of the green tapes. Detailed descriptions of the location of the carrying board are shown as below.

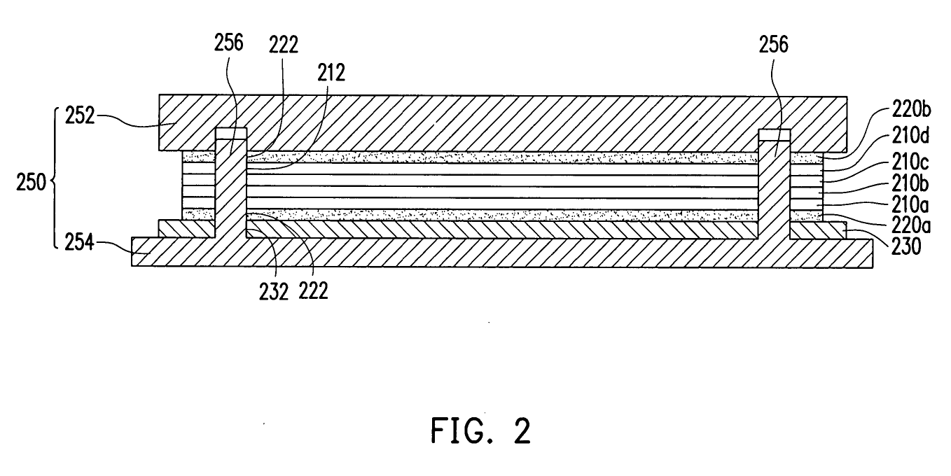

FIG. 2 is a cross sectional view showing a pre-parting multi-layer green tapes according to an embodiment of the present invention. The mold apparatus 250 comprises an upper mold 252 and a lower mold 254. The lower mold 254 comprises a plurality of pegs 256 for fixing the green tapes 210a-210d over the lower mold 254. After forming a circuit pattern (not shown) on the green tapes 210a-210d, a layering process is performed. The carrying board 230 is provided over the lower mold 254, wherein the carrying board 230 can be made of, for example, metal or plastic. The plastic mold 220a is provided over the carrying board 230. The green tapes 210a-210d are sequentially provided over the plastic mold 220a. The plastic mold 220b is then disposed over the green tape 210d. The carrying board 230, the plastic molds 220a and 220b, and the green tapes 210a-210d comprise holes 232, 222 and 212. During the layering process, the pegs 256 of the lower mold 254 fit into the holes 232, 222 and 212 of the carrying board 230, the plastic molds 220a and 220b, and the green tapes 210a-210d. Accordingly, the carrying board 230, the plastic molds 220a and 220b, and the green tapes 210a-210d can be fixed over the lower mold 254.

After providing the plastic mold 220b over the green tapes 210d, the upper mode 252 covers the plastic mold 220b. Then a compression process is performed. The upper mold 252 and the lower mold 254 compress the green tapes 210a-210d. Under a specified temperature, the green tapes adhere to each other so as to from a planar and solid green-tape stack structure.

Then a parting process is performed. The upper mold 252 is parted from the plastic mold 220b and the green tapes 210a-210d. By lifting the carrying board 230, the lower mold 254 is parted from the carrying board 230 and the green tapes 210a-210d. The green tapes 210a-210d are parted from the carrying board 230. The plastic molds 220a and 220b are then parted from the green tapes 210a-210d. Because the plastic mold 220a is provided between the upper mold 252 and the green tape 210d, the green tape 210d does not touch the carrying board 230.

During the parting process, the green tapes 201a-210d are parted from the lower mold 254 by lifting the carrying board 230. Without being affected by the pegs 256, the green tapes are substantially planar. After a sintering process, the substantially planed green tapes are obtained. In the process of fabricating the ceramic substrate, the planed green tapes can be obtained by performing only one compression step. Accordingly, the present invention is cost-effective. By only using the upper mold 252, the lower mold 254 and the carrying board 230, the apparatus of the present invention is low-cost.

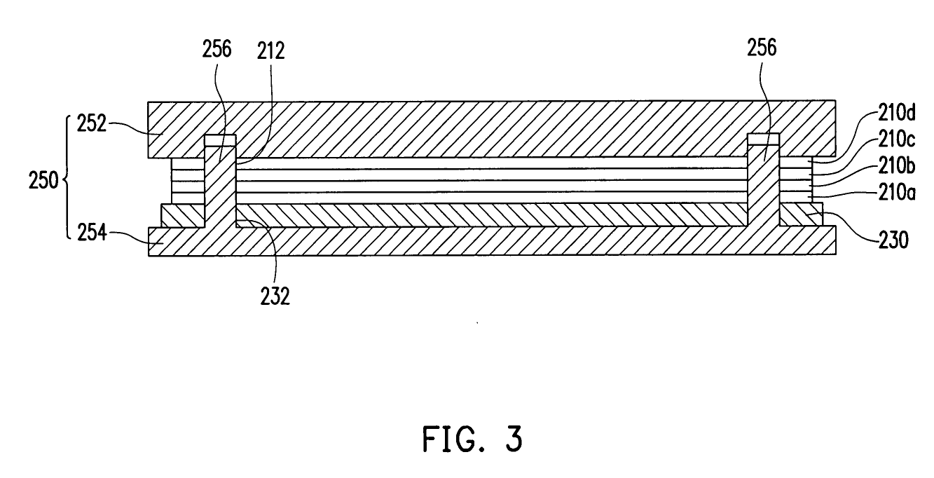

Following are the descriptions of a second embodiment of the present invention. In the first embodiment, plastic molds are provided between the upper mold and the green tapes, and between the carrying board and the green tapes so as to prevent the touch of the green tapes and the upper mold; and the green tapes and the carrying board. The present invention, however, is not limited thereto. If the carrying board is not adhesive to the green tapes, the plastic mold is not required. If the upper mold is not adhesive to the green tapes, the plastic mold can be saved as shown in FIG. 3.

FIG. 3 is a cross sectional view showing another pre-parting multi-layer green tapes according to an embodiment of the present invention. The process of this embodiment is similar to that of the first embodiment. What is different in this embodiment is that the plastic molds are saved. If the carrying board 230 is not very adhesive to the green tape 210a, the plastic mold 220a of FIG. 2 can be optionally saved. If the upper mold 252 is not very adhesive to the green tape 210d, the plastic mold 220b of FIG. 2 can be optionally saved. As a result, the upper mode 252 can directly touch the green tape 210d.

Accordingly, the method for fabricating a multi-layer ceramic substrate of the present invention has following advantages:

1. The method for fabricating a multi-layer ceramic substrate of the present invention merely requires a compression step so as to form a planar green-tape stack structure. The method is cost-effective.

2. The method for fabricating a multi-layer ceramic substrate of the present invention merely requires an upper mold, a lower mold and a carrying board. The present invention can achieve the object with the low-cost apparatus.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

1. A method form fabricating a multi-layer ceramic substrate by using a mold apparatus comprising an upper mold and a lower mold to compress a plurality of green tapes, the method comprising:
providing a carrying board over the lower mold;
providing a plastic mold over the carrying board;
providing the green tapes over the plastic board;
compressing the green tapes with the upper mold and the lower mold;
parting the upper mold from the green tapes and parting the lower mold from the carrying board; and
parting the green tapes from the plastic board.

2. The method form fabricating a multi-layer ceramic substrate of claim 1, wherein the carrying board is made of metal.

3. The method form fabricating a multi-layer ceramic substrate of claim 1, wherein the carrying board is made of plastic.

4. The method form fabricating a multi-layer ceramic substrate of claim 1, wherein a material of the carrying board is easily to be separated from the green tapes so as not to destroy the tapes while parting the green tapes from the carrying board.

5. The method form fabricating a multi-layer ceramic substrate of claim 1, wherein a material of the upper mode is easily to be separated from the green tapes so as not to destroy the tapes while parting the green tapes from the upper mold.

6. (canceled)

7. The method form fabricating a multi-layer ceramic substrate of claim 1, further comprising, after providing the green tapes over the carrying board, providing a plastic mold over the green tapes, and providing the upper mold over the plastic mold; and, after parting the green tapes from the carrying board, parting the plastic mold and the green tapes.

8. The method form fabricating a multi-layer ceramic substrate of claim 1, wherein the lower mold comprises a plurality of pegs and the carrying board comprises a plurality of holes, and while providing the carrying board over the lower mold, the pegs of the lower mold fit into the holes.
